(19) United States
(12) Patent Application Publication
(10) Pub. No.: US 2006/0224402 A1
(43) Pub. Date: Oct. 5, 2006

(54) Devices and methods for monitoring distributed services

(75) Inventors: George B. Hanna, Marietta, GA (US); Robert A. Koch, Norcross, GA (US)

Correspondence Address: WITHERS & KEYS FOR BELL SOUTH, P. O. BOX 71355, MARIETTA, GA, 30007-1355, US

(73) Assignee: BellSouth Intellectual Property Corporation

(21) Appl. No.: 11/098,094

(22) Filed: Apr. 4, 2005

(51) Int. Cl. G06Q 99/00

(52) U.S. Cl. 705/1; 705/412; 705/40; 700/295

(57) ABSTRACT

Devices and methods monitor the service being provided to a specific customer from a service provider, such as communications services including television and Internet access as well as non-communications services including water, gas, and electricity. A characteristic of the service is measured and it is detected whether the measured characteristic crosses a pre-defined threshold. When the threshold is crossed, a notification that is associated with the specific customer is then provided. The notification may be a visual display or a message that is sent through a network. The notification may be sent to the customer, the service provider, and/or a third party such as an independent monitoring agency. The notification may be used by the service provider for purposes of adjusting the bill for the service and/or for issuing a trouble-ticket to attempt repair of the issue. Furthermore, there may be multiple points being monitored along the pathway of the service such that the service provider may use the notifications to better locate problems in the pathway.

### TECHNICAL FIELD

The present invention is related to the monitoring of services provided to customers. More particularly, the present invention is related to the detection of characteristics of services and providing a corresponding notification.

### BACKGROUND

Services distributed by utility companies, such as communications service providers, are provided via networks and pathways. Communications service providers transmit signals to individual customers to deliver the requested service. Communications service providers include but are not limited to cable television companies, satellite television companies, wireless and wireline telephone companies, and Internet service providers. In each of these instances, the service provider transmits a signal via a pathway, e.g., wireline or wireless, to provide the requested service to each customer. Other service providers, such as water, gas, and electrical service providers, distribute services via networks and pathways such as through pipelines and electrical powerline wiring.

Due to one of a variety of reasons, the services being provided may be temporarily blocked or otherwise subjected to interference that prevents adequate delivery of the requested service to the customer. For example, a communication wireline may be severed or a piece of equipment in the pathway to the customer may fail, resulting in the service being unavailable for a period of time. As another example, factors such as weather or malfunctioning equipment may degrade the service pathway such that the service that reaches the customer is inadequate.

Typically, in return for paying a fee, the customer expects to receive the service at all times. However, because of issues with the service, such as those discussed above, the service may be unavailable at times. To account for these instances of unavailability it may be desirable from either the standpoint of the customer or the service provider that one of several things happens. For example, the customer may wish to receive a billing credit based on the duration of unavailable or inadequate service. As another example, the service provider may wish to discover and resolve the issue causing the unavailable or inadequate service as quickly as possible. However, conventional service providers lack the ability to adequately track and notify either customers or service providers of such instances of service issues.

### SUMMARY

According to exemplary embodiments, these issues and others are addressed by providing monitoring devices for monitoring the service going to specific customers. The monitoring device measures a characteristic of a service being provided to a specific customer. When the service is not what is expected, then a notification of such is generated. According to one or more embodiments, there may be multiple points of monitoring along the pathway for a customer and the service provider can determine the location of a problem based on which points provide a notification of the problem.

One embodiment is a device for monitoring aspects of a service being provided to a specific customer. The system includes a measurement component that measures a characteristic of a service being provided to the specific customer. The system also includes at least one notification component that provides a notification associated with the specific customer when the measured characteristic of the service crosses a pre-defined threshold.

Another embodiment is a method of monitoring service being provided to a specific customer from a service provider. The method involves measuring a characteristic of a service being provided from the service provider to the specific customer. The method further involves detecting whether the measured characteristic crosses a pre-defined threshold and when the measured characteristic crosses the pre-defined threshold, generating a notification that is associated with the specific customer.

Another embodiment is a computer readable medium containing instructions for monitoring service being provided to a specific customer from a service provider. The instructions when executed by a computer perform acts including measuring a characteristic of a service being provided from the service provider to the specific customer, detecting whether the measured characteristic crosses a pre-defined threshold, and when the measured characteristic crosses the pre-defined threshold, generating a notification that is associated with the specific customer.

### DESCRIPTION OF THE DRAWINGS

FIG. 1 illustrates one embodiment where a service is being provided to a customer from a service provider with the service being monitored at various points along a pathway.

FIG. 2 illustrates one embodiment of a monitoring device that includes various components for providing monitoring and notification in relation to the service being provided to the customer.

FIG. 3 illustrates one embodiment of an operational flow utilized to monitor and provide notification in relation to the service being provided to the customer.

FIG. 4 illustrates one embodiment of an operational flow utilized to respond to a notification being sent in relation to the service being provided to the customer.

### DETAILED DESCRIPTION

According to exemplary embodiments, the characteristics of services being provided from a service provider to a customer are monitored, and a notification is generated when the services is not as expected. As a result of the monitoring and notification, customers and/or service providers may be made aware of the situation so that appropriate action may be taken, such as an adjustment to a bill or generation of a trouble ticket.

For illustrative purposes, the following description is directed to monitoring of communication services. It should be appreciated, however, that the invention is not limited to monitoring of communications services but is also applicable to monitoring of other types of services, including but not limited to electrical, gas, and water services.

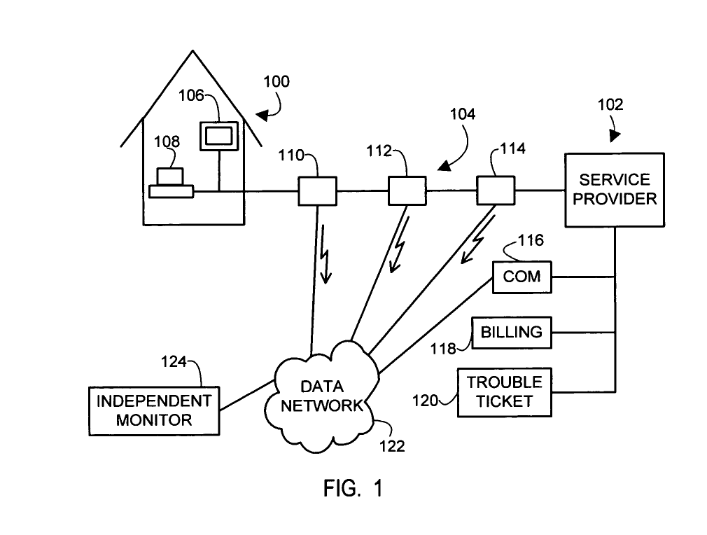

For purposes of example, FIG. 1 shows a customer premises 100 where a service is being provided, such as cable television. The service is provided from a service provider 102 to the customer premises 100 via a pathway 104. In this example, the pathway 104 is entirely a wireline, but it will be appreciated that other pathways for communications services are possible as well, including, for example, optical and wireless pathways. For non-communications services, pathways be include but are not limited to water pipelines, gas pipelines, and powerlines. At the customer premises 100, the service is distributed to the appropriate devices such as a television 106 and/or a personal computer 108. While FIG. 1 shows a single pathway 104 interconnecting the service provider 102 to the customer premises 100, it will be appreciated that there may be many pathways 104 leading to a single customer or to many separate customers and that the pathway 104 may include portions where services to multiple customers share the same pathway through a multiplexing scheme.

Distributed along the pathway 104 in this example, there are multiple individual monitoring devices 110, 112, and 114 that together form a comprehensive monitoring system. For illustrative purposes, three monitoring devices 110, 112, and 114 are shown in FIG. 1. However, it will be appreciated that there may be more or fewer monitoring devices, depending on the monitoring needs. In the embodiment shown in FIG. 1, each of the individual monitoring devices receives the service destined for the specific customer premises 100 and each allows the service to continue along the pathway 104 to the customer premises 100 so that service is not interrupted. However, each of these individual monitoring devices measures one or more characteristics of the service, such as voltage or data rate for communications services and pressure, flow rate, or voltage for non-communications services, and compares the measurement to a threshold that defines what is to be expected or what is known to be acceptable to the customer.

In addition to measuring the service characteristic, these monitoring devices also generate notifications when the comparison of the measurement to the threshold indicates that the service is not as expected. For example, a cable television signal has a minimum voltage necessary to provide a certain quality of television service. If the measured voltage dips below this minimum voltage, then a notification is generated. As another example, a data rate from an Internet service provider has a minimum number of bits per second that is within a best effort range expected by the customer. If the measured number of bits per second dips below this minimum rate, then a notification is generated. Likewise, for non-communications services, there may be a minimum flow rate, pressure, or voltage that is expected.

The notification may take one of various forms. For example, the notification may be a visual display of the start time, stop time, and/or total duration for when the service was not as expected. For purposes of notifying the customer directly, this display is most useful at the monitoring device located at or nearby the customer premises 100 where it is in view of the customer. However, the display may also be useful to technicians who are analyzing the pathway 104.

The notification may alternatively or additionally involve sending an electronic message. Examples include email messages or short message service messages, which may be sent through a data network 122 to the customer, to a third party monitoring entity 124, and/or to one or more systems 116, 118, and 120 of the service provider. The electronic message notification allows each of the monitoring devices 110, 112, and 114 to provide the notification on a real-time or near real-time basis and over great distances.

The notifications allow the interruption in service situation to be addressed. Providing a notification to the customer allows the customer to keep track of how much down-time the service is experiencing. This allows the customer to make educated choices about what services are worthwhile. Furthermore, knowing that the problem lies within the pathway 104, as opposed to within the customer premises. 100, allows the customer and the service provider to eliminate the equipment of the customer as the source of the problem. The customer being aware of the problem with the pathway 104 equips the customer for corresponding with the service provider to ensure that the service provider is aware of the problem, is making reasonable attempts to solve it, and is providing a credit or other billing adjustment.

In addition to or as an alternative to notifying the customer directly with a display or with an electronic message, the customer may employ a third party monitoring service 124. Any notification messages may be directed to the third party monitoring service 124 who may then correspond with the customer and/or the service provider. Customers may desire that the third party monitoring service 124 deal directly with the service provider 102 so that the third party monitoring service 124 contacts the service provider to ensure that the service provider is aware of the problem, is making reasonable attempts to solve it, and is providing a credit or other billing adjustment. Furthermore, the third party monitoring service 124 may track over significant periods of time the number and duration of instances when the service is not as expected and may offer this information to customers and/or service providers for purposes of comparison to other service providers and/or for purposes of negotiating billing adjustments or new service contracts.

To provide the electronic messages to the one or more destination addresses, each of the monitoring devices 110, 112, and 114 communicates through the data network 122. The data network 122 may be a wireline network, such as the public switched telephone network, a wireless based network, such as a cellular telephone network, or any other suitable communications network. Each of the individual monitoring devices 110, 112, and 114 may include the ability to communicate depending upon the type of data network 122 being relied upon. Additionally or alternatively, the monitoring devices 110, 112, and 114 may be configured to communicate via the pathway 104 that is being monitored during instances where communications via the pathway 104 is still possible, such as in the downstream direction to the customer premises 100, where there is a decrease in data rate below the threshold but data transfer upstream and/or downstream still occurs, or where the cable television line continues to carry data upstream to the service provider even though the cable television signal voltage has dropped below the threshold.

The service provider 102 may address the situation in various ways. Initially, the service provider may utilize a communications system 116 that is linked to the data network 122 and/or the pathway 104 in order to receive the notification messages. The communications system 116 may include an email server or client, short message service server or client, or other system capable of sending and receiving electronic messages. This communications system 116 may automatically generate an acknowledgement message to the customer or a third party to indicate that the service provider is aware of the service issue so that the customer or third party need not attempt to contact the service provider about the problem. Because the notification is customer specific, the communications system 116 is made aware of the particular customer experiencing the problem so that the acknowledgement message may be directed to the particular message address on file for the customer.

In addition to acknowledging the issue, the service provider 102 may also utilize the received notification to trigger a billing system 118 to record a billing adjustment for the customer. The notification may include a start time, stop time, and/or duration so that the billing system 118 may utilize this information to create a line item that makes an adjustment to the next bill to be provided to the customer such as a billing credit based on the total down-time for the service during the current billing period. For embodiments where multiple monitoring devices are included on the pathway 104, multiple monitoring devices may provide notification of the same issue, such as where the problem is located upstream near the service provider 102. In that case, the actual date and time may be included in the notification such that the billing system 118 accounts for the overlap of the down-time and does not create duplicate billing adjustments. This billing system 118 may be a fully automated process or may involve manual approval or entry of any billing adjustment.

The service provider 102 may also utilize the received notification to trigger a trouble ticket system 120 to issue a trouble ticket that identifies the pathway 104 that is experiencing the issue. The trouble ticket results in the dispatch of a technician who may then diagnose and repair the issue with the pathway 104 to restore service to its expected state. For embodiments where multiple monitoring devices are located along the pathway 104, the trouble ticket system 120 may benefit from application of logic to narrow down the potential location of the problem. Upon determining which monitoring device has a neighboring monitoring device that has not concurrently generated a notification, the trouble is likely to be somewhere between the monitoring device that generated the notification and its neighboring monitoring device that did not. Because the notification may identify the monitoring device that generated it and because the location of each monitoring device is known by the trouble ticket system 120, the trouble ticket system 120 may specify the area where the problem is located. As with the billing system 118, the trouble ticket system 120 may be a fully automated process or may involve manual approval or entry of any trouble ticket.

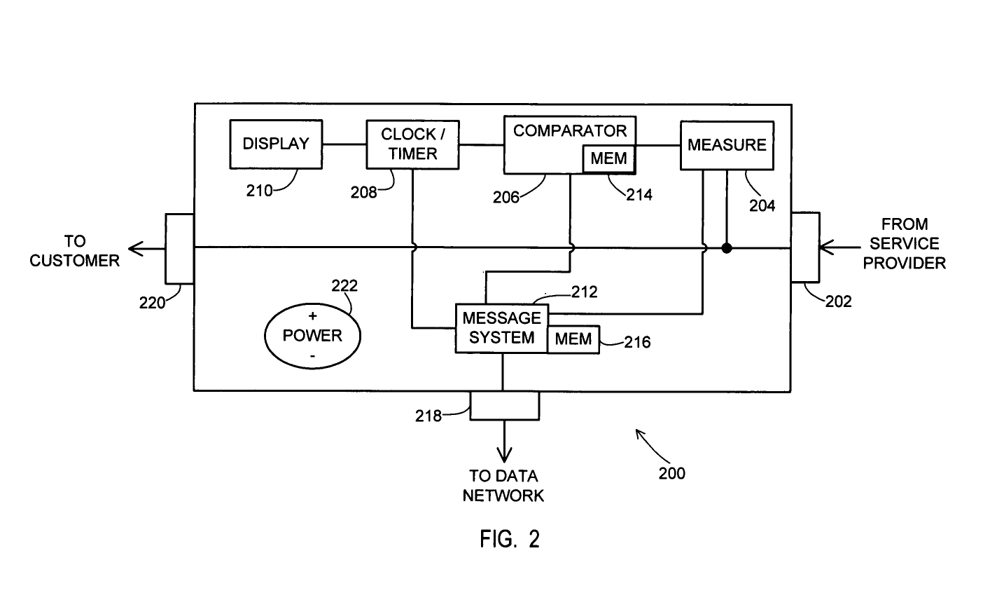

FIG. 2 shows one example of an individual monitoring device 200 that may be used as one or more of the monitoring devices 110, 112, and 114 of FIG. 1. The monitoring device 200 depicted in FIG. 2 monitors characteristics of a service, such as by monitoring a communications signal. Those skilled in the art will appreciate that similar types of monitoring devices may be used to monitor characteristics of other types of services such as gas, water, and electricity. In the embodiment shown in FIG. 2, the monitoring device 200 includes an input port 202 for receiving the signal from the service provider. Upon being received, the signal is then passed-through to an output port 220 for passing the signal back onto the pathway where it may proceed to the customer premises in substantially the same condition as it is in when received at input port 202. The input port 202 and output port 220 may vary depending upon the particular pathway being used. Examples for communications services include twisted pair connections, coaxial cable connections, and antennas for wireless signal paths, while examples for non-communications services include pipelines and powerlines.

Within the monitoring device 200, the signal is first acquired by a measuring component 204. The measuring component may obtain a sample value depending upon the particular characteristic being measured. If the monitoring device 200 is attempting to detect whether there is adequate signal present or not, then the measuring component 204 may periodically sample a peak or average voltage. As an alternative, the measuring component 204 may continuously measure a peak or average voltage as opposed to taking periodic samples. Furthermore, the measuring component 204 may measure values other than voltage such as frequency or may measure voltage corresponding to a particular frequency.

If the monitoring device 200 is attempting to detect data rate, then the measuring component 204 may take the form of a communications device having a network address and being capable of sending and receiving data packets of a known length and determining the length of time that elapses for a sent packet to arrive at a destination address and a response of a known length to be returned. For example, a ping may be addressed to a particular IP address within the service provider network and a measurement of elapsed time made for the response to the ping to be received. As an alternative, the measurement component 204 may utilize a message component 212 to send and receive the test packets.

For embodiments where non-communications services are being monitored, the measuring component 204 may measure pressure, flow rate, or other similar characteristics. For example, a minimum water pressure or gas pressure may be expected and the measuring component may measure what the current water pressure or gas pressure is within the pathway leading to the customer premises.

Upon obtaining a measured value for the particular service characteristic of interest, the measurement component 204 may then provide the measurement to a comparator 206. In this case of sampled values where the measurement is data as opposed to an analog signal, then the comparator 206 may compare the measurement value to a threshold value that is stored in memory 214. When the comparator 206 finds that the measured value has crossed the threshold value, then the comparator 206 may then output a trigger to a message system 212. The comparator 206 may also output a trigger to a clock/timer 208. Likewise, when the comparator 206 finds that the measured value has re-crossed the threshold, then a second trigger may be sent to the message system 212 and/or the clock/timer 208.

The clock/timer 208 may utilize the triggers to initiate timing of the duration of the service issue and/or to capture the start time and stop time of the service issue. The clock/timer 208 may output its count, start time, and stop time to the message system 212 and/or to the display 210. In embodiments where the display 210 is present, the display may provide a visual indication of the duration, start and stop times of the service issue as well as any other information that may be directed to it. For example, the measurement component 204 may feed the measured value of voltage, data rate, or other characteristic such as pressure or flow rate to the display 210.

The message component 212 includes a transmission system and a message application such as a thin email client. The message component 212 may also include memory 216 for storing information necessary for sending the notification of the service issue. The information may include relevant addresses to which the electronic notification messages are to be sent, the identification of the monitoring device 200, the identification of the specific customer account for the pathway being monitored, and various other pieces of information that may be relevant to notification messages. The message component 212 includes an interface 218 to the data network, such as a port connected to a wireline network or an antenna that is in communication with a wireless network.

The monitoring device 200 also includes a power source 222. The power source may be an adapter that receives public utility high-voltage alternating current power and converts it to the low-voltage direct current power typically employed by electronic circuits forming the previously discussed devices. The power source 222 may alternatively by a battery providing the low-voltage direct current power or may include a battery as a back-up to the public utility. Other alternative power sources are also applicable including solar cells and fuel cells.

The embodiment shown in FIG. 2 may be implemented in various ways. For example, the components of the monitoring device 200 may be implemented as hardware. Each of the components may be individual devices, or several of the components may be incorporated into a single application specific device. Furthermore, part or all of the functionality of the monitoring device of FIG. 2 may be implemented in software, i.e., a computer readable medium, that includes instructions executing on a processor of a general-purpose computer system. The particular manner in which the functions of the monitoring device are implemented is a design choice. Furthermore, the monitoring device 200 may be implemented as a stand-alone device or may be integrated into other systems, such as the television 106, a set top box, the personal computer 108, or other device within the customer premises 100.

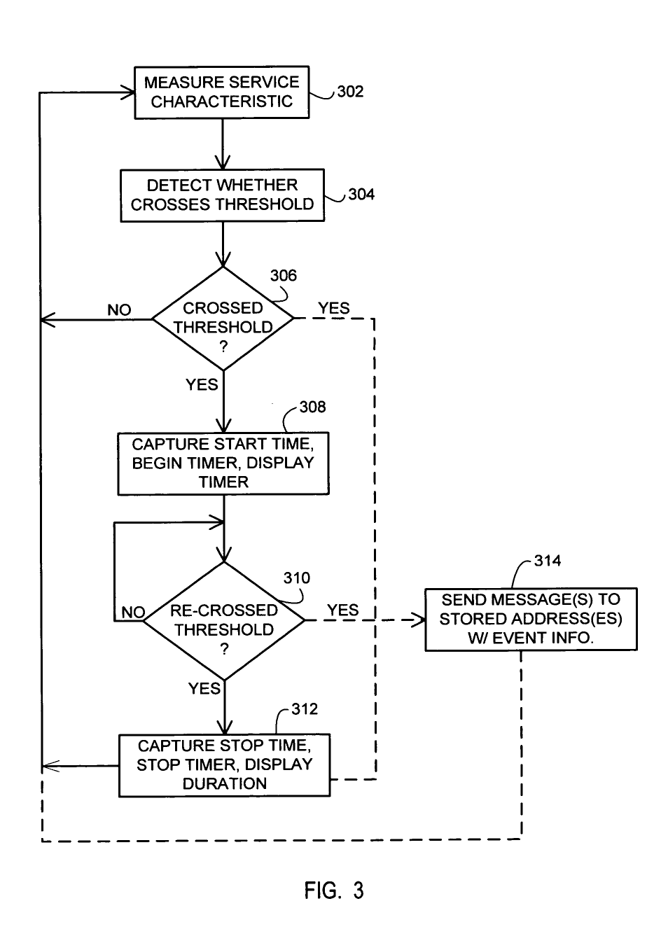

FIG. 3 shows an example of the logical operations that may be performed within the monitoring device 200 of FIG. 2 and which are performed separately by each of the individual monitoring devices 110, 112, and 114 of FIG. 1. Initially, the monitoring device measures the service characteristic of interest at measure operation 302. Here, for example, the voltage level may be periodically sampled or continuously obtained or the data rate may be periodically determined. Once the measurement is obtained, the value is compared to a threshold to detect whether the measurement has crossed the threshold at compare operation 304. For example, the voltage or data rate values may be compared to a floor and/or ceiling threshold to determine if the service is as expected.

Upon the comparison to the threshold, query operation 306 detects whether the threshold has initially been crossed. If the threshold has not been crossed, then the measurements continue at measure operation 302 without generating any notification from this particular monitoring device since the service is currently operating as expected from the vantage point of this particular monitoring device. If query operation 306 detects that the threshold has been crossed, then the gathering of information about the service issue begins at capture operation 308. For example, the start time based on when the value crossed the threshold is obtained. Additionally or alternatively, a timer may be started to track the duration of the service issue. Also, for embodiment including a display to provide a notification of the service issue, the start time and/or timer count may be displayed.

Once the initial information is captured, measure operation 302 continues to measure the service characteristic and compare operation 304 continues to compare the measured value to the threshold. During this time, query operation 310 begins detecting whether the comparison indicates that the measured value has re-crossed the threshold. Once it is detected that the measured value has re-crossed the threshold, then the final information for the service issue is gathered at capture operation 312. For example, the stop time based on when the value re-crossed the threshold is obtained. Additionally or alternatively, the timer may be stopped to provide the total duration of the service issue. The stop time and/or total duration may then be displayed. Thereafter, measuring of the service characteristic carries on at measure operation 302.

For embodiments that include a message component for sending an electronic message to provide a notification of the service issue, one or more electronic messages may be sent for each service issue. One or more messages may be sent once the measured value has crossed the threshold. For example, upon query operation 306 detecting that the measured value has crossed the threshold, then a message may be sent at message operation 314 to provide a real-time alert to the service provider, customer, or third party monitoring service of the occurrence of the service issue. A message may be sent at message operation 314 upon the gathering of the initial information about the service issue at capture operation 308. In that case, the initial information that has been gathered, such as the start time and the most current measured value, may be included in the message.

In addition to sending messages once the measured value has crossed the threshold, one or more messages may also be sent once the measured value has re-crossed the threshold. For example, upon query operation 310 detecting that the measured value has re-crossed the threshold, then a message may be sent at message operation 314 to provide a real-time alert to the service provider, customer, or third party monitoring service of the end of the service issue. A message may be sent at message operation 314 upon the gathering of the final information about the service issue at capture operation 312. In that case, the final information that has been gathered, such as the stop time or total duration and the most current measured value, may be included in the message. Furthermore, any latter message for an instance of a service issue may also contain the information of a previous message for the same instance of the service issue. For embodiments where a single message is sent, then any information gathered up to that point may be included, such as the start time, initial measured value, stop time, and final measured value.

Each message may be sent to one or more recipient addresses stored in memory of the message component. Furthermore, certain messages may be sent to certain addresses while other messages are sent to other addresses. For example, every message for a service issue may be sent to the service provider, but the final message may also be sent to the customer to provide only a summary of the service issue to the customer. Each message is based on an event and each event may be associated with one or more recipient addresses in order to determine where each message should be directed. Additionally, as previously discussed above, the notification messages may include other information that identifies the customer to the service provider or third party monitor and that identifies the particular monitoring device that is sending the message.

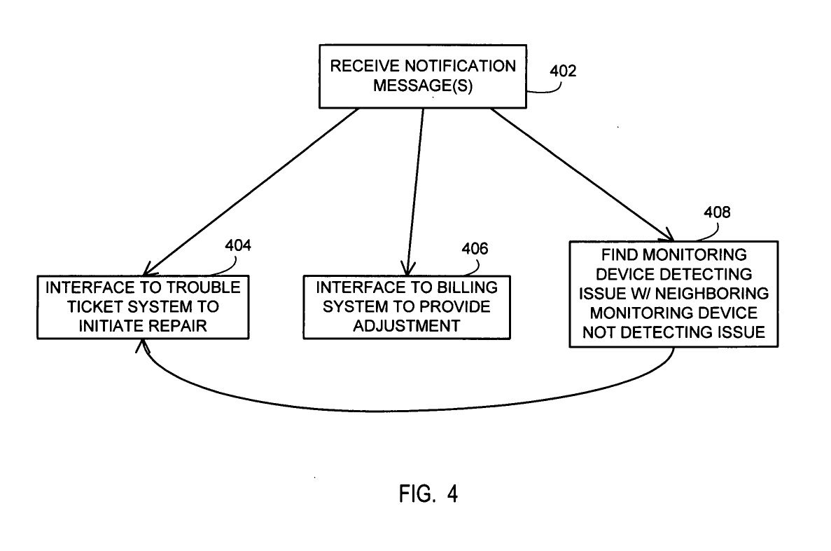

FIG. 4 shows one example of the logical operations that may be performed by the service provider in response to the messages that serve as notification of the service issue. The notification message is initially received at message operation 402. The received message may then result in the communications system that has received the message interfacing with the trouble ticket system to provide the details from the message that describe the service issue at communication operation 404. The trouble ticket system may then issue a trouble ticket based on the information of the message, including the identity of the most relevant monitoring device 200, the identity of the customer, and any technical details such as the most current measured value to initiate a diagnosis and repair by a technician.

The received message may also result in the communications system that has received the message interfacing with the billing system to provide the details from the message at communication operation 406. The billing system may then enter an adjustment as a line item on the bill for the current billing period to provide the customer with reparation for the amount of time during the billing period that the service was not as expected.

Where there are multiple monitoring devices for a given pathway of a customer, the received message may also result in the service provider analyzing a series of received messages for the particular pathway at analysis operation 408 in order to better locate the problem. This analysis may involve determining which monitoring devices of the pathway have generated a notification and then determining which of these monitoring devices has a neighboring monitoring device that has not generated a notification message. The problem is most likely located between the monitoring device that has generated the notice and the neighboring monitoring device that has not. Once the likely location of the problem is determined through this analysis, then this information may be provided to the trouble ticket system to be included in the trouble ticket for this particular service issue. The technician may then begin the diagnosis at this suggested location rather than starting at a potentially irrelevant location.

Referring again to FIG. 1 for an example of this analysis, if there is a problem in the pathway 104 between monitoring device 112 and monitoring device 114, the signal reaching monitoring device 114 may not be affected while the signal reaching monitoring devices 110 and 112 is affected. In that case, monitoring devices 110 and 112 both generate a notification message but monitoring device 114 does not. Therefore, the service provider 102 will then analyze the messages for this pathway and determine that monitoring devices 110 and 112 detect the problem but monitoring device 114, which neighbors monitoring device 112, does not detect the problem. Therefore, the problem is most likely located somewhere between monitoring device 112 and neighboring monitoring device 114. Because the location of each monitoring device 110, 112, and 114 is known, this information allows a technician to begin diagnosing the problem between monitoring device 112 and 114 rather than starting at a less relevant point such as at the customer premises 100.

The discussion above has been with respect to service issues that detract from the service being provided. However, the monitoring device may also be applied to detect service issues that include exceeding the level or quality of service that is expected. For example, the data rate that is detected may exceed a ceiling threshold and a notification may be sent to the customer to inform the customer that the service is exceeding expectations.

Furthermore, the service issue that is detected may not be a result of the service provider problem but may instead be an issue with the use of the service by the customer. For example, data rate measurements may detect the length of time the maximum data rate is being continuously utilized by the customer. The monitoring device may have a threshold as a matter of time where a floor threshold indicates whether the current data rate is more than is necessary due to only very short periods of use of the full data rate versus a ceiling threshold that indicates whether the current data rate is not enough due to very lengthy periods of use of the full data rate. Notification may be sent to the customer and/or service provider to inform them of the data rate usage.

While the invention has been particularly shown and described with reference to various embodiments thereof, it will be understood by those skilled in the art that various other changes in the form and details may be made therein without departing from the spirit and scope of the invention.

What is claimed is:

1. A device for monitoring a service being provided to a specific customer, comprising:
a measurement component that measures a characteristic of service being provided to the specific customer; and
at least one notification component that provides a notification associated with the specific customer responsive to the measured characteristic of the service crossing a pre-defined threshold.

2. The device of claim 1, wherein the service is a communications service.

3. The device of claim 1, wherein the at least one notification component comprises a display that provides visual information in response to the measured characteristic of the service crossing the pre-defined threshold.

4. The device of claim 1, wherein the at least one notification component sends a message addressed to the specific customer to notify the specific customer about the measured characteristic crossing the pre-defined threshold.

5. The device of claim 1, wherein the at least one notification component sends a notification message addressed to a service to notify the service provider about the measured characteristic crossing the pre-defined threshold.

6. The device of claim 5 wherein at least one of a trouble ticket and a billing credit associated with the specific customer is generated in response to the notification message.

7. The device of claim 1, wherein the at least one notification device sends a message addressed to a monitoring entity that is independent of a service provider providing the service.

8. The device of claim 1, wherein the characteristic measured includes a voltage level, and the pre-defined threshold is a minimum voltage level necessary for delivery of the service.

9. The device of claim 1, wherein characteristic measured includes a data rate, and pre-defined threshold is a minimum agreed upon data rate for the service.

10. A method of monitoring service being provided to a specific customer from a service provider, comprising:
measuring a characteristic of a service being provided from the service provider to the specific customer;
detecting whether the measured characteristic crosses a pre-defined threshold; and
when the measured characteristic crosses the pre-defined threshold, generating a notification that is associated with the specific customer.

11. The method of claim 10, wherein generating a notification comprises providing a visual display including at least one of start time, stop time, and duration of when the measured characteristic crosses the pre-defined threshold.

12. The method of claim 10, wherein the characteristic is voltage level and wherein the pre-defined threshold is a minimum voltage level necessary for delivery of the service.

13. The method of claim 10, wherein the characteristic is data rate and wherein the pre-defined threshold is a minimum agreed upon data rate for the service.

14. The method of claim 10, wherein generating the notification comprises sending a message via a network connection to the specific customer.

15. The method of claim 10, wherein generating the notification comprises sending a message via a network connection to the service provider.

16. The method of claim 15, further comprising generating a trouble ticket in response to receiving the notification.

17. The method of claim 15, further comprising generating a billing credit in response to receiving the notification.

18. The method of claim 15, further comprising sending a message from the service provider to the customer to acknowledge receiving the notification.

19. The method of claim 10, wherein generating the notification comprises sending a message via a network connection to an independent monitoring service.

20. A computer readable medium containing instructions for monitoring service being provided to a specific customer from a service provider, the instructions when executed by a computer perform acts comprising:
measuring a characteristic of a service being provided from the service provider to the specific customer;
detecting whether the measured characteristic crosses a pre-defined threshold; and
when the measured characteristic crosses the pre-defined threshold, generating a notification that is associated with the specific customer.
